(19) United States
(12) Patent Application Publication
(10) Pub. No.: US 2026/0369213 A1
(43) Pub. Date: Nov. 19, 2026

(54) DISPLAY MODULE WITH STORAGE OF AN IMAGE IN AN INTERNAL MEMORY

(71) Applicant: VALEO VISION, Bobigny (FR)

(72) Inventors: Jose AFONSO, Bobigny (FR); Gunnar VIKBERG, Bobigny (FR)

(73) Assignee: VALEO VISION, Bobigny (FR)

(21) Appl. No.: 19/144,110

(22) PCT Filed: Dec. 20, 2023
(86) PCT No.: PCT/EP2023/086776

§ 371 Date: Jun. 27, 2025

(30) Foreign Application Priority Data
Dec. 29, 2022 (FR) FR2214676

(51) Int. Cl. G09G 3/20; G09G 3/32

(52) U.S. Cl. CPC G09G 3/2096; G09G 3/32; G09G 2320/0693; G09G 2360/18; G09G 2370/022; G09G 2370/045; G09G 2380/10

(57) ABSTRACT

The invention relates to a method for displaying data, the method being implemented in a display module comprising a screen and a control module suitable for controlling light elements of the screen according to data over a data interface. The display module comprises a memory storing at least one image. The method comprises the steps of:—upon detecting (202; 203) a lack of availability of data over the data interface and receiving a power supply signal over at least one power supply interface, accessing (204), by means of the control module, the at least one image in the memory;—controlling (205), by means of the control module, the light elements to display the at least one image.

### TECHNICAL FIELD

The present invention relates to the field of display of visual data, and in particular of image data. The invention is in particular, but not exclusively, applicable to images displayed for the purposes of performing luminous functions, such as an esthetic function or a signaling function in an automotive vehicle.

### BACKGROUND OF THE INVENTION

It is known to use display modules comprising a screen inside or outside an automotive vehicle, in order to perform a signaling function or for esthetic reasons. For example, it may be a question of a welcome display displayed when the vehicle is started up, but also of a signaling or esthetic display displayed while the vehicle is switched on.

Such a display module generally receives still images or a series of images of a video, via a data channel from a control module of the vehicle, and for example from a graphics processing unit (GPU) such as a graphics card.

In the event of unavailability of data on the data channel, for example due to a fault or a boot time of the graphics card, the display module generally does not display any image, this causing a service interruption, or a delay, in the esthetic or signaling function.

There is thus a need to allow better continuity or reactivity in the production of luminous functions performed by a display module, in particular for an automotive vehicle.

To this end, a first aspect of the invention relates to a method for displaying data, the method being implemented in a display module comprising a screen and a control module that is capable of controlling luminous elements of said screen depending on data received by the display module on a data interface, the display module comprising a memory storing at least one image, the method comprising the following steps:
upon detection of unavailability of data on the data interface and of receipt of a power signal over at least one power interface, access by the control module to said at least one image in the memory;
control of said luminous elements by the control module to display said at least one image.

Local storage of at least one image in the display module makes it possible to ensure continuity in luminous, esthetic or signaling functions when data are unavailable on the input interface. In the event of a delay in receipt of data over the data interface, it enables better responsiveness in the display of a luminous function.

In embodiments, the unavailability of data on the data interface may be an absence of receipt of data over the data interface or receipt of data containing errors.

### SUMMARY OF THE INVENTION

Thus, the method according to the invention makes it possible to ensure better continuity or responsiveness in the display, for a number of causes of unavailability of data on the data interface, including when the received data are corrupted or contain errors.

In embodiments, when the detection of unavailability of data on the data interface is consecutive to initial operating conditions under which data are received over the data interface and a power signal is received over said at least one power interface, the detection of unavailability may comprise detection of an interruption of receipt of data over the data interface and the control module may access at least one first image in the memory and may control said luminous elements to display said at least one first image.

Thus, display of a first default image in case of unavailability of data is allowed. The first image may indicate that the display device is in fail-safe or FSO mode or may freeze the luminous function that was being performed under the initial operating conditions.

In addition or as a variant, when the detection of unavailability is consecutive to initial operating conditions under which no data is received over the data interface and no power signal is received over said at least one power interface, the detection of unavailability may be detection of an absence of data on the data interface while a power signal is being received over said at least one power interface, and the control module may access at least one second image in the memory, the at least one second image preferably being different from the first image, and may control said luminous elements to display said at least one second image.

The responsiveness associated with the luminous function performed by the display module is thus improved. Specifically, the luminous module generally receives data from a GPU the start-up time of which causes a delay in receipt of data over the data interface.

In addition, said at least one second image may be a series of second images forming an animation.

It is thus possible to produce a welcome animation on start-up of the display module, this being advantageous, in particular when the display module is integrated into equipment such as motor-vehicle equipment.

In addition or as a variant, the method may further comprise, following display of said at least one second image, receipt of screen calibration data, and storage in the memory of the calibration data by the control module.

Such an embodiment is advantageous, in particular when the display module is first booted. The calibration data then allow the display of the image stored in memory to be improved.

When the second image is different from the first image, it will be understood that it is possible to display a second image for a welcome scenario when all the components of the automotive vehicle have not yet been initialized, and a first image indicating that the display device is in fail-safe or FSO mode. In this way, it is possible for the user to observe, by simple visual inspection, a malfunction in the communication between the vehicle and the device when the device displays the first image, while benefiting from a welcome scenario using the second image.

In addition, the method may further comprise, after display of said at least one second image, a wait for a predetermined time for receipt of data over the data interface, after which, after the predetermined time has elapsed and if no data has been received, the first image is displayed instead of the second image.

Such an embodiment makes it possible to display the first image, for example to inform of the malfunction of the communication between the vehicle and the device when the second image was displayed when the display module was booted, or to display a default image corresponding to performance of the display function, this being advantageous when the second image corresponds to a welcome scenario and might not meet the regulatory constraints of motor-vehicle signaling devices; for example, the image of the welcome scenario may have colorimetry-related or photometry-related characteristics that are incompatible with these regulatory constraints. In another example, and in the specific case where the at least one second image is a succession of images forming an animation, the standards in force in most countries at the time of filing of the application do not allow an animation to be displayed while the vehicle is being driven.

According to embodiments, the method may further comprise receipt of an update of said at least one image over the data interface, and writing by the control module to the memory to replace said at least one image with the update.

This makes it possible to update the image stored in the memory, this allowing the customization of the luminous functions performed by the display module to be improved and the default image or luminous animation displayed in case of unavailability of data and power to be varied.

According to embodiments, the method may further comprise storage of said at least one image in the memory of the display module, prior to a first employment of said display module.

Thus, it is not necessary to configure the display module when it is first employed.

A second aspect of the invention relates to a computer program comprising instructions for implementing the method according to the first aspect of the invention, when these instructions are executed by a processor.

A third aspect of the invention relates to a display module comprising:
a memory storing at least one image;
at least one power interface capable of receiving a power signal;
a data interface capable of receiving data;
a screen comprising a plurality of luminous elements;
a control module capable of controlling the luminous elements of the screen depending on the data received over the data interface, of detecting unavailability of the data on the input interface, and capable of, upon detection of unavailability when a power signal is being received, accessing said at least one image in the memory and controlling the luminous elements to display said at least one image.

### BRIEF DESCRIPTION OF THE DRAWINGS

Other features and advantages of the invention will become apparent on examining the following detailed description and the appended drawings, in which:

FIG. 1 illustrates a display system according to embodiments of the invention; and

FIG. 2 is a chart illustrating the steps of a method for displaying an image according to embodiments of the invention.

### DETAILED DESCRIPTION OF THE INVENTION

The description concentrates on the features that differentiate the method and display module from those known in the prior art.

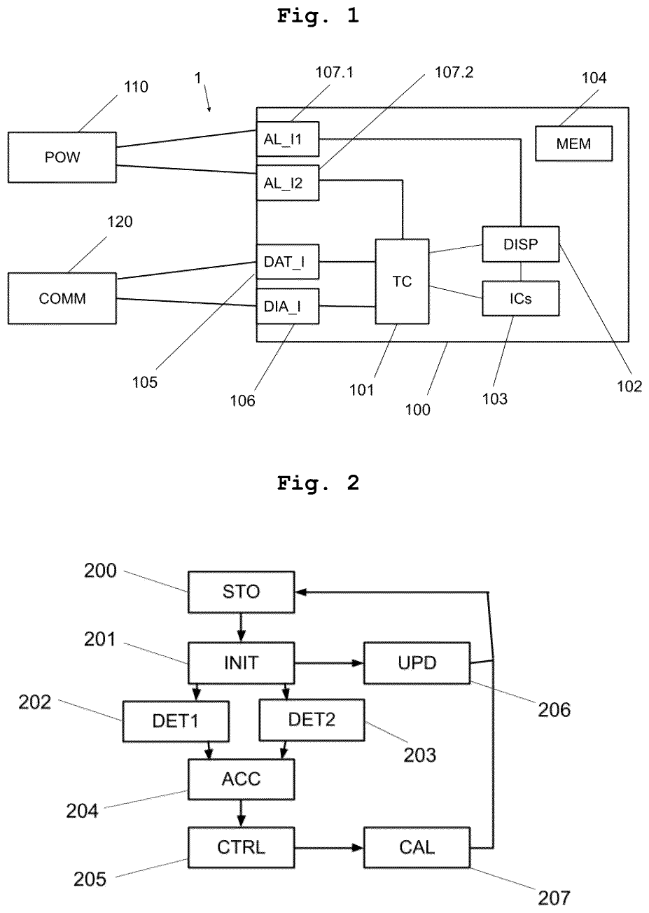

FIG. 1 illustrates a display system 1 for an automotive vehicle according to embodiments of the invention.

The display system 1 comprises a display module 100 capable of performing at least one luminous function among an esthetic function and/or a signaling function. The signaling function comprises the display of data for informational purposes to a user. The display module 100 may be integrated into a piece of exterior equipment of an automotive vehicle, in particular for a signaling function, or into a piece of interior equipment of an automotive vehicle, in particular for a signaling function intended to signal something to the driver, or for an esthetic function such as display of a welcome message when the vehicle is started up. No restrictions are placed on the piece of equipment into which the display module 100 is integrated, it potentially being a body part, a headlight, a door, a dashboard element or any other interior or exterior equipment of an automotive vehicle.

The display module 100 comprises a control module 101 capable of controlling a screen 102, in particular depending on image or video data received via a first interface 105, referred to as the data interface 105 below.

No restrictions are placed on the technology of the screen 102, which may comprise an array of individually controllable luminous elements.

In embodiments, each of the luminous elements may be a light-emitting semiconductor chip the dimensions of which are between 150 μm and 300 μm. Such a chip is called a mini-LED. As a variant, and preferably, each of the luminous elements comprises at least one light-emitting semiconductor chip the dimensions of which are less than 150 μm, and for example between 5 μm and 80 μm. Such a chip is called a micro-LED. Such chips may be mounted, directly or indirectly, on a substrate, such as a ceramic substrate. Ceramic substrate is given to mean a substrate made from a material having a crystalline, or partially crystalline or amorphous structure, such as a glass or an alumina, made up of essentially inorganic substances, and which is formed by a molten mass that solidifies as it cools, or which is formed and matured, at the same time or subsequently, through the action of heat and/or pressure. Advantageously, the ceramic substrate is a substrate made of alumina (Al2O3) or indeed a substrate made of aluminum nitride (AlN). It will be noted that a glass substrate (borosilicate glass) is more commonly used due to its dielectric properties and production cost. The substrate may have a thickness of between 400 and 600 μm, and for example equal to 500 μm. As a variant, the substrate may be an HDI PCB, with a thickness of between 400 and 600 μm, and for example equal to 500 μm, in the case of active-matrix light-source control, or of between 900 and 1100 μm, and for example equal to 1 mm, in the case of passive-matrix control of the luminous elements.

As a variant, the luminous elements may be organic LEDs, or OLEDs, for example with active-matrix control (a.k.a. AMOLEDs). As another variant, the luminous elements may be LCD cells, LCD standing for Liquid Crystal Display.

As indicated, the control module 101 may control the luminous elements of the screen using an active matrix or, preferably, a passive matrix.

When an active matrix is used, the control module 101 commands respective control elements associated with each of the luminous elements or with a group of luminous elements.

Each luminous element is thus associated with one active control element. Advantageously, each luminous element is mounted on and connected to the control element with which it is associated. For example, each control element comprises a thin-film transistor (TFT) on and to which the associated luminous element or the associated group of luminous elements is mounted and connected. The plurality of luminous elements of the screen 102 and the plurality of active control elements together form an active matrix. As a variant, the emitting side of the substrate may comprise one or more thin connection sub-layers, in particular of a thickness less than 50 μm, incorporating a plurality of active control elements, each active control element being arranged to control at least one of the luminous elements with which it is associated, and each luminous element being mounted on and connected directly to the emitting side of the substrate, substantially plumb with a control element for controlling the one or more thin connection layers, to which element it is connected. Each control element may be a microelectronic circuit, comprising at least one transistor and a memory.

When a passive matrix is used, the control module 101 is capable of sequentially connecting and disconnecting each of the luminous elements to power, received via a first power interface 107.1 described below, and to ground. In this case, the luminous elements may be mounted directly on the emission face of the substrate, forming a passive matrix, and control units 103 may be arranged to control the passive matrix depending on control instructions received by the control module 101. In order to produce such a passive matrix, the display module 100 may comprise a plurality of devices for controlling the electrical power delivered to the luminous elements, the control devices possibly being mounted on the side opposite the emitting side of the substrate. Each control device may be mounted on the opposite side near a through-hole with a view to controlling the electrical power delivered to a luminous element on the other side of the through-hole, on the light-emitting side of the substrate.

A set of control devices may be controlled by a control unit 103, each control unit possibly being an integrated circuit. For example, such integrated circuits 103 may in particular control several hundred luminous elements, via their respective control devices. The luminous elements of the screen 102 are thus divided into subsets of luminous elements, each subset of luminous elements being controlled by the control module 101 via a dedicated control unit 103.

For example, each control unit 103 may allow an array of 16*48, i.e. 768 luminous elements to be controlled. The display module 100 may thus comprise several tens of control units 103, for example between 20 and 40 control units 103, and in particular 30 control units 103.

Preferably, the control module 101, the control units 103 and the luminous elements of the screen 102 are arranged on the same substrate, this decreasing bulk since the number of cables is then restricted to the cables connected to the interfaces 105, 106, 107.1 and 107.2 described below.

The control module 101 is thus responsible for distributing control signals between the control units 103, so as to allow consistent display of an image obtained using the various subsets of luminous elements. The control module 101 thus forms a time controller. This type of control is well known and will not be described in more detail in the present description.

It will be noted that in the embodiment in which the luminous elements are controlled using an active matrix, the display module 100 does not comprise the control units 103, the control module 101 controlling the control elements associated with the luminous elements directly.

The display module 100 differs from a lighting module capable of projecting light. In the display module 100, the luminous elements of the screen 102 are placed directly facing a protective pane so as to be directly visible from outside the display module 100. In contrast, in a lighting module, the luminous elements emit light that is projected out of the lighting module by a projecting optical system that may comprise one or more lenses and/or mirrors, and the luminous elements are not directly visible from outside the lighting module.

The display module 100 of FIG. 1 further comprises:
a data interface 105 capable of receiving data, such as still images or a video stream, from a graphics control module 120, or GPU, such as a graphics card for example. The control module is thus capable of sending image or video data, from which the control module 101 determines control signals intended for the control elements 103, in the passive-matrix embodiment. The data interface 105 is generally unidirectional, and is capable of receiving image data from the GPU 120, without being able to send data back;
a diagnostic interface 106, allowing the control module 101 to exchange, bidirectionally, diagnostic data with the GPU 120 or with another control module of the vehicle, such as a central ECU for example, ECU standing for Electronic Control Unit.

The luminous elements of the screen 102 are powered by a power supply 110 of the vehicle via a first power supply interface 107.1. The control module 101 is for its part powered by a power supply 110 of the vehicle via a second control power supply interface 107.2.

The power supply 110 may further power the GPU 120, via a power cable not shown in FIG. 1.

The control module 101 may preferably comprise a processor such as a microcontroller element. The control module 101 may in particular comprise a field-programmable gate array (FPGA), an application-specific integrated circuit (ASIC) or a complex programmable logic device (CPLD). These elements are configured by means of a suitable computer program to implement the steps described with reference to FIG. 2.

The display module 100 may further comprise a memory 104 such as a random-access memory (RAM) or a read-only memory (ROM) or any other type of memory: flash, EEPROM, etc. As a variant, the memory 402 comprises multiple memories of the abovementioned types.

The memory 402 is preferably a non-volatile memory. The memory 104 is preferably a flash memory.

An interruption of the luminous, signaling or esthetic function, or a delay in the implementation of such a luminous function, may occur in the prior-art solutions. This is in particular the case when the vehicle is started up. Specifically, when the vehicle is started up, the power supply 110 delivers power to the display module 100 and to the GPU 120. However, when the GPU 120 is booted, a delay occurs in receipt of data via the data interface 105 by the display module 100. During this delay, the control module 101 does not receive any image data and cannot therefore control the screen 102 to display an image or an animation. This results in a delay in the display of an image or of an animation, this being particularly disadvantageous in the case of a welcome scenario. In another context, in the event of a fault on the data interface 105, for example in the event of interruption of the received data, or in the event of receipt of corrupted or error-containing data, the luminous function performed by the display module 100 is interrupted. The display module 100 may then enter a fail-safe or FSO mode, FSO standing for Fail Safe Operation.

In order to avoid such interruptions or delays in luminous functions, the present invention makes provision for storage of a still image or of a video/animation in the memory 104, the image or video being displayed in the event of unavailability of data on the data interface 105, as will be better understood on reading the description of FIG. 2. The unavailability may be an absence of data flow, due to a delay starting up or a failure of the GPU 120, or may be the receipt of corrupted or error-containing data.

The control module 101 is thus capable of gaining read access to the data stored in the memory 104, and in particular to the stored image or video. Furthermore, optionally, the control module 101 may be capable of gaining write access to the memory 104, in particular with a view to updating the stored image or video, or to storing calibration data relating to the screen 102. In particular, when the vehicle is first turned on, calibration data may be received by the control module 101 via the data interface 105 or the diagnostic interface 106. These calibration data may describe the operation of the luminous elements of the screen 102, or may allow compensation for differences in power or color between the luminous elements. No restrictions are placed on the nature of the calibration data. Furthermore, the control module 101 may receive an image update or an update of a series of images forming an animation via the data interface 105, and may store such an update, in replacement of the previous image or series of images, in the memory 104.

FIG. 2 shows a chart illustrating the steps of a method for displaying data implemented by a display module 100 according to embodiments of the invention.

In a step 200, at least one image is stored in the memory 104. Such an image may be a still image, by default, or may be a series of images forming an animation, such as a welcome animation. For example, the memory 104 may store a first image that is a default image to be displayed in the event of interruption of the receipt of data on the data interface 105, as described below. In addition or as a variant, the memory 104 may store at least one second image, and preferably a series of second images forming a welcome animation, to be displayed when the vehicle is started up, during the time for which no data is available on the data interface 105, because the GPU 120 is booting. Preferably, the duration of the animation is equal to the boot time of the GPU 120, or equal to the boot time of the GPU to within 10%.

In a step 201, the display module 100 is under initial operating conditions. The adjective “initial” designates the conditions prior to steps 202 and 203 described below. Under the first initial conditions, the display module 100 is powered by the power supply 110 and receives data on the data interface 105 from the GPU, and the control module 101 controls the luminous elements of the screen 102 depending on the received data. The first initial conditions may thus be nominal operating conditions. Under, alternative, second initial conditions, the display module 100 is not powered by the power supply 110 and receives no data from the GPU 120. Such initial conditions may in particular correspond to a situation in which an automotive vehicle comprising the system 1 is switched off.

In a step 202, the control module 101 detects unavailability of the data on the data interface 106, and in a step 203, the control module 101 detects that the display module 100 is being powered by the power supply 110. Detection of the unavailability of data and detection of the fact that power is being supplied are thus cumulative conditions that must be met simultaneously for step 204 described below to be implemented. Unavailability of data may correspond:
to the absence of data on the input interface, either due to a delay in switching on the GPU 120 or due to an interruption in the receipt of data; or
to receipt of corrupted or error-containing data on the data interface 105.

Following steps 202 and 203, the control module 101 gains read access to at least one of the images stored in the memory 104, in a step 204.

The unavailability may thus be an interruption in the receipt of data or detection of errors in the received data, following the first initial conditions. Specifically, the data channel is a “fragile” channel and such interruptions may occur. In the event of detection of such an interruption in receipt of data or in the event of detection of errors, despite continuity in the power received by the display module 100, the control module 101 is able to gain read access to the first default image in a step 204, and able to control the screen 102 so as to display the default image in a step 205. The aforementioned unavailability may result from the activation of an FSO mode. Activation of the FSO mode may be initiated by the control module 101 upon detection of a fault on the data interface 105, such as absence of data, or upon detection of a fault, or of errors, in the received data themselves, or even upon receipt of a fault message on the diagnostic interface 106, from the GPU 120 for example. When the control module 101 detects a fault on the data interface 105 or in the received data, activation of the FSO mode may be flagged to the GPU via the diagnostic interface 106.

As a variant, the unavailability of the data on the data interface 105 may be a delay in the receipt of the data, in particular following turn on of a vehicle comprising the system 1. In this case, power is received by the display module 100 as soon as the vehicle is turned on, but the GPU 120 generally takes several seconds to boot, this creating a fault in receipt of data over the data interface 105. Such a fault is thus consecutive to the second initial conditions, under which the power supply 110 and the GPU 120 are initially not on. On detection of an absence of receipt of data, following the second initial conditions and while power is being received over the interface 107.1, the control module 101 is able to gain read access to said at least one second image different from the first image in the memory 104, in step 204, and able to control the luminous elements of the screen 102 so as to display said at least one second image. As explained above, said at least one second image may be an animation such as a welcome animation, this making it possible to display such an animation while the GPU is booting.

The control module 101 is thus capable of differentiating between the detections of steps 202 and 203, which are consecutive to the first initial conditions, and the detections of steps 202 and 203, which are consecutive to the second initial conditions, when the memory stores the first image, and said at least one second image. As a variant, the control module 101 is capable of implementing steps 202 and 203 only after the first initial conditions, or only after the second initial conditions, when the memory 104 stores only the first image or only said at least one second image.

In an optional step 206, the control module 101 may receive an update of at least one image stored in the memory 104, via the data interface 105. Such an update may in particular be received under the first initial conditions described above, when data are being received over the data interface 105 and when the display module 100 is being powered. The image update may be received from the GPU 120 or from another module, such as a module for receiving cellular data of an automotive vehicle for example. A signal may be received over the diagnostic interface 106 indicating that the data received over the data interface 105 are image-update data. Such a signal may indicate whether the updating relates to the first image or to said at least one second image, when the memory 104 stores a plurality of images. On receipt of such an update, the control module 101 is able to gain write access to the memory 104 in order to replace the image with the update of the image.

In an optional other step 207, the control module 101 may receive calibration data. Such calibration data may in particular be received following the first boot of the display module 100, and following display of a third image, called the calibration image, or following display of the at least one second image as a variant. Thus, the memory 104 may further store a third image to be displayed when the vehicle is first turned on, i.e. when the steps 202 and 203 following the second initial conditions are first implemented. In this case, an external device may evaluate calibration data depending on the display of the third image, or of the at least one second image, on the screen 102, and communicate these data to the display module 100. Specifically, the luminous elements may exhibit variations in power and/or color, and the storage of calibration data in the memory 104 in step 207 allows the control module 101 to take into account the calibration data when controlling the luminous elements of the screen 102. As a variant, the calibration data are used by the control module 101 to modify the images stored in the memory 104, and it is then not necessary to take into account the calibration data when controlling the screen 102.

The present invention is not limited to the embodiments described above by way of example, but extends to other variants.

What is claimed is:

1. A method for displaying data, the method being implemented in a display module with a screen and a control module that is capable of controlling luminous elements of the screen depending on data received by the display module over a data interface, the display module includes a memory storing at least one image, the method comprising:
upon detection of unavailability of data on the data interface and of receipt of a power signal over at least one power interface, access by the control module to the at least one image in the memory;
control of the luminous elements by the control module to display at least one image.

2. The method as claimed in claim 1, wherein the unavailability of data on the data interface is an absence of receipt of data over the data interface or receipt of data containing errors.

3. The method as claimed in claim 1, wherein when the detection of unavailability of data on the data interface is consecutive to initial operating conditions under which data are received over the data interface and a power signal is received over the at least one power interface, the detection of unavailability includes detection of an interruption of receipt of data over the data interface and the control module accesses at least one first image in the memory and controls the luminous elements to display the at least one first image.

4. The method as claimed in claim 1, wherein when the detection of unavailability is consecutive to initial operating conditions under which no data is received over the data interface and no power signal is received over the at least one power interface, the detection of unavailability is detection of an absence of data on the data interface while a power signal is being received over the at least one power interface and the control module accesses at least one second image in the memory and controls the luminous elements to display the at least one second image.

5. The method as claimed in claim 4, wherein the at least one second image is different from the first image.

6. The method as claimed in claim 4, wherein the at least one second image is a series of second images forming an animation.

7. The method as claimed in claim 4, further comprising, following display of the at least one second image, receipt of screen calibration data, and storage in the memory of the calibration data by the control module.

8. The method as claimed in claim 1, further comprising receipt of an update of the at least one image over the data interface, and writing by the control module to the memory to replace the at least one image with the update.

9. The method as claimed in claim 1, further comprising storage of the at least one image in the memory of the display module, prior to a first employment of the display module.

10. (canceled)

11. A display module comprising:
a memory) storing at least one image;
at least one power interface capable of receiving a power signal;
a data interface capable of receiving data;
a screen comprising a plurality of luminous elements;
a control module capable of controlling the luminous elements of the screen depending on the data received over the data interface, of detecting unavailability of the data on the input interface, and capable of, upon detection of unavailability when a power signal is being received, accessing the at least one image in the memory and controlling the luminous elements to display the at least one image.
